(19) United States
(12) Patent Application Publication
(10) Pub. No.: US 2020/0150495 A1
(43) Pub. Date: May 14, 2020

(54) DISPLAY PANEL AND DISPLAY DEVICE

(71) Applicants: HKC Corporation Limited, Shenzhen (CN); Chongqing HKC Optoelectronics Technology Co., Ltd., Chongqing (CN)

(72) Inventor: Zeyao Li, Shenzhen (CN)

(21) Appl. No.: 16/426,006

(22) Filed: May 30, 2019

Related U.S. Application Data
(63) Continuation of application No. PCT/CN2018/122090, filed on Dec. 19, 2018.

(30) Foreign Application Priority Data
Nov. 12, 2018 (CN) 201821857993.4

(51) Int. Cl. G02F 1/1343; G09G 3/34

(52) U.S. Cl. CPC G02F 1/134309; G02F 2001/134345; G02F 1/13439; G09G 3/3413

(57) ABSTRACT

The present disclosure discloses a display panel, and a display device, the display panel includes a first substrate, defining a pixel electrode; a second substrate, facing the first substrate, a surface of the second substrate facing the first substrate defines a common electrode, and the common electrode faces the pixel electrode; a liquid crystal layer, defined between the second substrate and the first substrate; and an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different.

### CROSS-REFERENCE TO RELATED APPLICATIONS

The present application is a Continuation Application of PCT Application No. PCT/CN2018/122090 filed on Dec. 19, 2018, which claims the benefit of China Patent Application No. 201821857993.4, filed on Nov. 12, 2018, with the State Intellectual Property Office and entitled “display panel and display device”, the entirety of which is hereby incorporated herein by reference.

### TECHNICAL FIELD

The present disclosure generally relates to the technical field of liquid crystal display, and more particularly relates to a display panel, and a display device.

### BACKGROUND

Currently, liquid crystal displays are widely used for various electronic products.

However, due to the axial light transmission characteristics of liquid crystal molecules, when the view angle of the display screen is two large, color shift often occurs when viewing from the lateral side of the display screen, causing serious distortion of the images presented for people. Therefore, solving the color shift problem is an important breakthrough to improve the large view angle of the liquid crystal display. The statements herein merely provide background information related to the present disclosure and do not necessarily constitute prior art.

### SUMMARY

It is therefore one main object of the disclosure to provide a display panel, which aims to improve the color shift of the display panel and enlarge the view angle.

In order to realize the above aim, the display panel provided by the present disclosure includes:

a first substrate, the first substrate defines a pixel electrode;

a second substrate, facing the first substrate, a surface of the second substrate facing the first substrate defines a common electrode, and the common electrode faces the pixel electrode;

a liquid crystal layer, defined between the second substrate and the first substrate; and

an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different.

Electively, the insulating layer is defined on a surface of the common electrode near the liquid crystal layer.

Electively, the second substrate includes a base substrate, and a black matrix, a color resistance layer, and a dielectric layer all sequentially defined on the base substrate, the common electrode is defined on a surface of the dielectric layer away from the color resistance layer, and a surface of the dielectric layer near the common electrode is defined as a third surface, a surface of the dielectric layer away from the common electrode is defined as a fourth surface, and vertical distances between the third surface and the fourth surface are different.

Electively, the third surface defines a first groove, the common electrode defines a second groove corresponding to the first groove, the second groove is received in the first groove, and the second surface defines a protrusion accommodated in the second groove.

Electively, the plane of an end of the protrusion located is parallel to the first surface, and the vertical distances between the planes of two sides of the second surface without the protrusion located and the first surface are defined as d1 and d4 respectively, d1=d4.

Electively, the third surface is an inclined surface, and the second surface matches with the inclined surface.

Electively, the third surface is an arc-shaped surface, and the second surface matches with the arc-shaped surface.

Electively, the first substrate defines data lines, scan lines, and a plurality of pixel units defined by the data lines and the scan lines, each of the pixel units includes a plurality of sub pixels, and each of the sub pixels includes the pixel electrode.

Electively, the pixel unit has an eight-domain structure.

Electively, a display panel includes:

a first substrate, the first substrate defines a pixel electrode;

a second substrate, facing the first substrate, a surface of the second substrate facing the first substrate defines a common electrode, and the common electrode faces the pixel electrode;

a liquid crystal layer, defined between the second substrate and the first substrate; and

an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different;

the second substrate includes a base substrate, and a black matrix, a color resistance layer, and a dielectric layer all sequentially defined on the base substrate, the common electrode is defined on a surface of the dielectric layer away from the color resistance layer, and a surface of the dielectric layer near the common electrode is defined as a third surface, a surface of the dielectric layer away from the common electrode is defined as a fourth surface, and vertical distances between the third surface and the fourth surface are different, the third surface is an inclined surface, and the second surface matches with the inclined surface.

The present disclosure further provides a display device, the display device includes a display panel, the display panel includes:

a first substrate, the first substrate defines a pixel electrode;

a second substrate, facing the first substrate, a surface of the second substrate facing the first substrate defines a common electrode, and the common electrode faces the pixel electrode;

a liquid crystal layer, defined between the second substrate and the first substrate; and

an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different.

The display panel of the present disclosure includes the first substrate, the second substrate, the liquid crystal layer, and the insulating layer, the first substrate defines the pixel electrode and the second substrate defines the common electrode. By arranging the first surface of the insulating layer close to the liquid crystal layer to be flush with the liquid crystal layer, the vertical distances between the second surface and the first surface of the insulating layer are different, so that the deflection angles of liquid crystal molecules are different, and the functions of compensating the view angle and improving the color shift are achieved, which not only does not increase the difficulty of the preparation process and does not increase the cost, but also does not reduce the effective display area of the display panel. That is, the opening ratio of the display panel is not reduced, thus realizing the large view angle display effect.

### BRIEF DESCRIPTION OF THE DRAWINGS

To better illustrate the technical solutions that are reflected in various embodiments according to this disclosure or that are found in the prior art, the accompanying drawings intended for the description of the embodiments herein or for the prior art will now be briefly described, it is evident that the accompanying drawings listed in the following description show merely some embodiments according to this disclosure, and that those having ordinary skill in the art will be able to obtain other drawings based on the arrangements shown in these drawings without making inventive efforts.

FIG. 1 is a structural diagram of the second substrate of the present disclosure according to some embodiments;

FIG. 2 is a cross sectional diagram of the display panel shown in FIG. 1;

FIG. 3 is a schematic circuit diagram of FIG. 2;

FIG. 4 is a cross sectional diagram of the subject display panel of the present disclosure according to another embodiments.

Labels illustration for drawings:

| Label | Name |
|---|---|
| 100 | display panel |
| 10 | first substrate |
| 11 | pixel electrode |
| 12 | data line |
| 13 | scan line |
| 14 | pixel unit |
| 20 | second substrate |
| 21 | common electrode |
| 210 | second groove |
| 22 | base substrate |
| 23 | black matrix |
| 24 | color resistance layer |
| 25 | dielectric layer |
| 251 | first groove |
| 30 | liquid crystal layer |
| 40 | insulating layer |
| 41 | protrusion |
| 411 | first surface |
| 412 | second surface |

The realization of the aim, functional characteristics, advantages of the present disclosure are further described specifically with reference to the accompanying drawings and embodiments.

### DETAILED DESCRIPTION

The technical solutions of the embodiments of the present disclosure will be clearly and completely described in the following with reference to the accompanying drawings. It is obvious that the embodiments to be described are only a part rather than all of the embodiments of the present disclosure. All other embodiments obtained by persons skilled in the art based on the embodiments of the present disclosure without creative efforts shall fall within the protection scope of the present disclosure.

It is to be understood that, all of the directional instructions in the exemplary embodiments of the present disclosure (such as top, down, left, right, front, back . . . ) can only be used for explaining relative position relations, moving condition of the elements under a special form (referring to figures), and so on, if the special form changes, the directional instructions changes accordingly.

It should be further noted that in depictions of the present disclosure, terms such as “connect” should be understood in a broad sense, unless otherwise prescribed or defined explicitly. In other words, the connection can be a fixed connection, a removable connection or an integral connection. Of course, the connection can also be a direct connection, an indirect connection via an intermediary, or an internal communication between two elements. For a person having ordinary skills in the art, he/she can understand specific meanings of the above terms in the present disclosure upon specific situations.

In addition, the descriptions, such as the “first”, the “second” in the exemplary embodiment of present disclosure, can only be used for describing the aim of description, and cannot be understood as indicating or suggesting relative importance or impliedly indicating the number of the indicated technical character. Therefore, the character indicated by the “first”, the “second” can express or impliedly include at least one character. In addition, the technical proposal of each exemplary embodiment can be combined with each other, however the technical proposal must base on that the ordinary skill in that art can realize the technical proposal, when the combination of the technical proposals occurs contradiction or cannot realize, it should consider that the combination of the technical proposals does not existed, and is not contained in the protection scope required by the present disclosure.

The present disclosure provides a display panel 100.

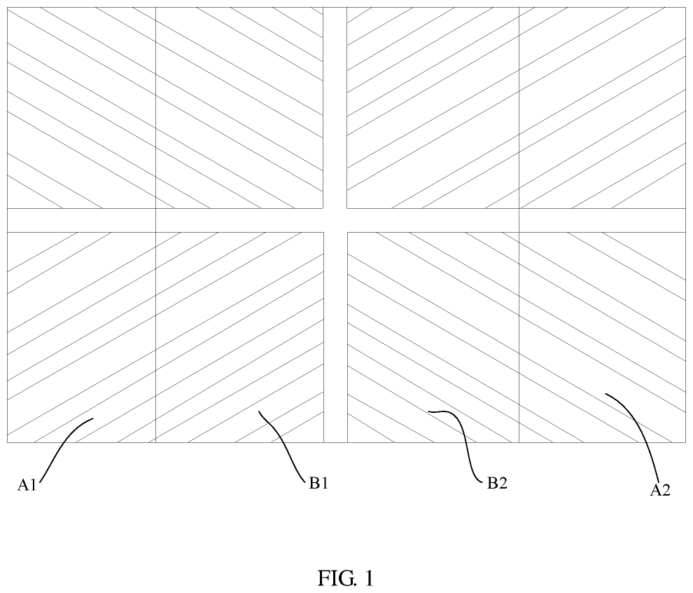

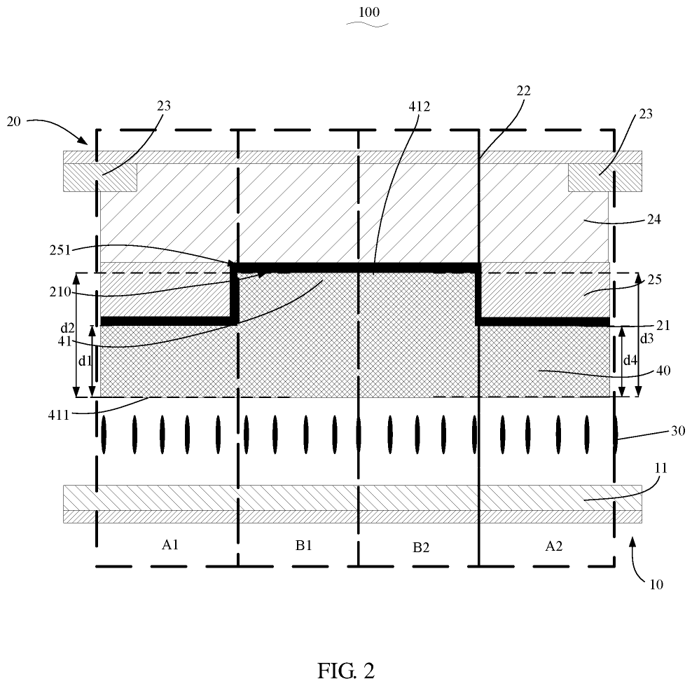

Referring to FIGS. 1 to 4, in some embodiments of the present disclosure, the display panel 100 includes:

a first substrate 10, the first substrate 10 defines a pixel electrode 11;

a second substrate 20, facing the first substrate 10, the surface of the second substrate 20 facing the first substrate 10 defines a common electrode 21, and the common electrode 21 faces the pixel electrode 11;

a liquid crystal layer 30, defined between the second substrate 20 and the first substrate 10; and

an insulating layer 40, configured to isolate the liquid crystal layer 30 from the common electrode 21, or isolate the liquid crystal layer 30 from the pixel electrode 11, a surface of the insulating layer 40 near the liquid crystal layer 30 is defined as a first surface 411, the first surface 411 is flush with the liquid crystal layer 30, a surface of the insulating layer 40 away from the liquid crystal layer 30 is defined as a second surface 412, and vertical distances between the second surface 412 and the first surface 411 are different.

Specifically, the first substrate 10 and the second substrate 20 are both transparent substrates, such as glass substrates, quartz substrates, etc. The pixel electrode 11 and the common electrode 21 are respectively formed on an inner side of the first substrate 10 and an inner side of the second substrate 20 facing the inner side of the first substrate 10, and the liquid crystal layer 30 is provided between the first substrate 10 and the second substrate 20. By applying a driving voltage between the pixel electrode 11 and the common electrode 21, the rotation of liquid crystal molecules in the liquid crystal layer 30 is controlled by the electric field formed between the pixel electrode 11 and the common electrode 21, so as to refract the light of the backlight module to generate an image.

The pixel electrode 11 of the first substrate 10 may be a translucent electrode or a reflective electrode. When the pixel electrode 11 is the translucent electrode, the pixel electrode 11 may include a transparent conductive layer. The transparent conductive layer may include at least one selected from a group consisting of indium tin oxide (ITO), indium zinc oxide (IZO), zinc oxide (ZnO), indium oxide (In₂O₃), indium gallium oxide (IGO), and aluminum zinc oxide (AZO), for example. In addition to the transparent conductive layer, the pixel electrode 11 may include a transflective layer arranged to improve light emission efficiency. The transflective layer may be a thin layer (e.g., the thin layer has a thickness of several nanometers to tens of nanometers) and may include at least one selected from a group consisting of Ag, Mg, Al, Pt, Pd, Au, Ni, Nd, IR, Cr, Li, Ca, and Yb.

The insulating layer 40 is defined between the liquid crystal layer 30 and the common electrode 21, or between the liquid crystal layer 30 and the pixel electrode 11. It can be understood that the insulating layer 40 may be defined between the common electrode 21 and the liquid crystal layer 30, or between the pixel electrode 11 and the liquid crystal layer 30, and the location of the insulating layer 40 is not limited here. The vertical distances between the second surface 412 and the first surface 411 of the insulating layer 40 are different, so that the thicknesses between the common electrode 21 and the pixel electrode 11 in different regions may be different, and the voltage across the liquid crystal layer 30 in different regions may also be different, which makes the threshold voltage of the voltage penetration (V-T) characteristic curve between them also different. In regions of the insulating layer 40 with large thickness, the threshold voltage difference may also be large, thus achieving the effect of low color shift.

The display panel 100 of the present disclosure includes the first substrate 10, the second substrate 20, the liquid crystal layer 30, and the insulating layer 40, the first substrate 10 defines the pixel electrode 11 and the second substrate 20 defines the common electrode 21. By arranging the first surface 411 of the insulating layer 40 close to the liquid crystal layer 30 to be flush with the liquid crystal layer 30, the vertical distances between the second surface 412 and the first surface 411 of the insulating layer 40 are different, so that the deflection angles of liquid crystal molecules are different, and the functions of compensating the view angle and improving the color shift are achieved, which not only does not increase the difficulty of the preparation process and does not increase the cost, but also does not reduce the effective display area of the display panel 100. That is, the opening ratio of the display panel 100 is not reduced, thus realizing the large view angle display effect.

In some embodiments, since the driving circuit defined on the first substrate 10 is more complex than that on the second substrate 20, the insulating layer 40 can be optionally defined on the surface of the common electrode 21 near the liquid crystal layer 30, to simplify the process steps.

In some embodiments, the second substrate 20 includes a base substrate 22, and a black matrix 23, a color barrier layer 24, and a dielectric layer 25 sequentially defined on the base substrate 22. The common electrode 21 is defined on the surface of the dielectric layer 25 away from the color barrier layer 24, the surface of the dielectric layer 25 near the common electrode 21 is defined as a third surface, the surface of the dielectric layer 25 away from the common electrode 21 is defined as a fourth surface, and the vertical distances between the third surface and the fourth surface are different.

In some embodiments, the second substrate 20 includes the base substrate 22, the black matrix 23, the color resist layer 24, and the dielectric layer 25, the base substrate 22 may be a transparent substrate that does not affect the passage of the backlight and provides a basic carrier, the base substrate 22 may be a glass substrate or a quartz substrate. The color resistance layer 24 is located in the light-transmitting region of the black matrix 23. The dielectric layer 25 is made of a material with insulating properties, and the dielectric layer 25 and the insulating layer 40 may be made of the same material or different materials, and the materials of the dielectric layer 25 and the insulating layer 40 are not limited here. The common electrode 21 is sandwiched between the dielectric layer 25 and the insulating layer 40, and the thickness of the common electrode 21 in its extending direction is uniform. When the common electrode 21 is defined on the dielectric layer 25, the common electrode 21 matches with the third surface of the dielectric layer 25 in shape, and the second surface 412 of the insulating layer 40 matches with the common electrode 21 in shape. The vertical distances between the third surface and the fourth surface of the dielectric layer 25 are different, so that the thicknesses of different regions between the common electrode 21 and the pixel electrode 11 are different, and the voltage across the liquid crystal layer 30 in different regions may be different, which makes the threshold voltage of the voltage penetration (V-T) characteristic curve between them also different. In regions of the insulating layer 40 with large thickness, the threshold voltage difference may also be large, thus achieving the effect of low color shift.

Referring to FIGS. 1 to 3, in some embodiments of the present disclosure, the third surface defines a first groove 251, the common electrode 21 defines a second groove 210 corresponding to the first groove 251, the second groove 210 is received in the first groove 251, and the second surface 412 defines a protrusion 41 accommodated in the second groove 210.

In some embodiments, different regions of the dielectric layer 25 have different thicknesses, that is, the third surface defines the first groove 251, the common electrode 21 defines the second groove 210, the second groove 210 is received in the first groove 251, and the second surface 412 defines the protrusion 41 accommodated in the second groove 210, as such the thicknesses between the common electrode 21 and the pixel electrode 11 are non-uniform.

In some embodiments, the plane of an end of the protrusion 41 located is parallel to the first surface 411, and the vertical distances between the planes of two sides of the second surface 412 without the protrusion 41 located and the first surface 411 are defined as d1 and d4 respectively, d1=d4.

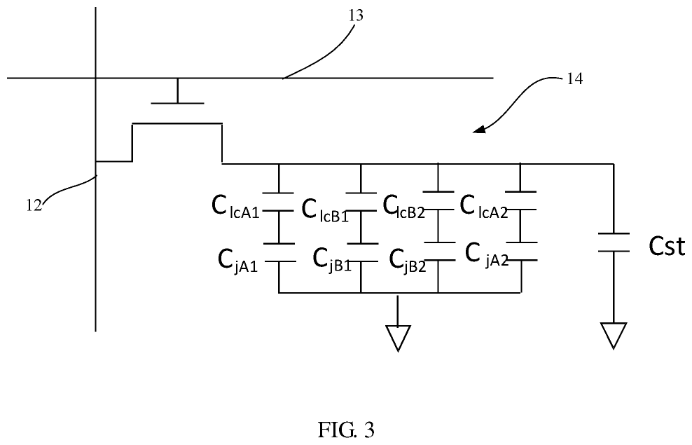

In some embodiments, the thicknesses of the insulating layer 40 sandwiched between the common electrode 21 and the liquid crystal layer 30 are non-uniform. According to FIG. 1, each pixel unit 14 facing the second substrate 20 and the first substrate 10 is divided into four regions: a first domain display region A1, a second domain display region B1, a third domain display region B2, and a fourth domain display region A2. The distances between the common electrode 21 in four regions and the liquid crystal layer 30 are defined as d1, d2, d3, d4, respectively. In some embodiments, d1=d4, d2=d3, d2>d1. Please referring to FIG. 3, the liquid crystal layer 30 and the insulating layer 40 are sandwiched between the pixel electrode 11 and the common electrode 21, it can be understood that, capacitance Clc and capacitance Cj can be formed between the pixel electrode 11 and the common electrode 21. In the first domain display region A1, capacitance ClcA1 and capacitance CjA1 can be formed between the pixel electrode 11 and the common electrode 21. In the second domain display region B1, capacitance ClcB1 and capacitance CjB1 can be formed between the pixel electrode 11 and the common electrode 21. In the third domain display region B2, capacitance ClcB2 and capacitance CjB2 can be formed between the pixel electrode 11 and the common electrode 21. In the fourth domain display area A2, capacitance ClcA2 and capacitance CjA2 can be formed between the pixel electrode 11 and the common electrode 21. Since the voltage across the pixel electrode 11 and the common electrode 21 remains the same in the four regions A1, A2, B1 and B2, but the thickness d1 (d4) and the thickness d2 (d3) of the insulating layer 40 in the regions A1 (A2) and B1 (B2) are different, the voltage across the liquid crystal layer 30 in region A1 (A2) and region B1 (B2) may also be different, which makes the threshold voltage of the voltage penetration (V-T) characteristic curve between them also different. When the different between the thickness d1 (d4) and the thickness d2 (d3) of the insulating layer 40 increases, the threshold voltage difference may also be increase, thus achieving the effect of low color shift.

Referring to FIG. 3, the first substrate 10 defines data lines 12, scan lines 13, and a plurality of pixel units 14 defined by the data lines 12 and the scan lines 13, each of the pixel units includes a plurality of sub pixels, and each of the sub pixels includes the pixel electrode 11.

In some embodiments, the first substrate 10 defines data lines 12, scan lines 13, and the plurality of pixel units 14 defined by the data lines 12 and the scan lines 13. Each pixel unit includes the plurality of sub pixels, each sub pixel includes the pixel electrode 11, and the pixel electrode 11 is internally provided with stripe branches with different orientations. Each orientation area of the stripe branches is defined as a domain. In some embodiments, each pixel unit 14 is divided into four areas: a first domain display area A1, a second domain display area B1, a third domain display area B2, and a fourth domain display area A2, each domain display area is divided into two domains which have the same size and are symmetrically arranged by a horizontal spacing band. As such the pixel unit 14 forms an eight domain structure. As the thicknesses of the different portions of the regions between the common electrode 21 and the liquid crystal later 30 are different, the color shifts are different in different regions. This design realizes the eight-domain design without increasing the number of thin film transistors and increases the aperture ratio.

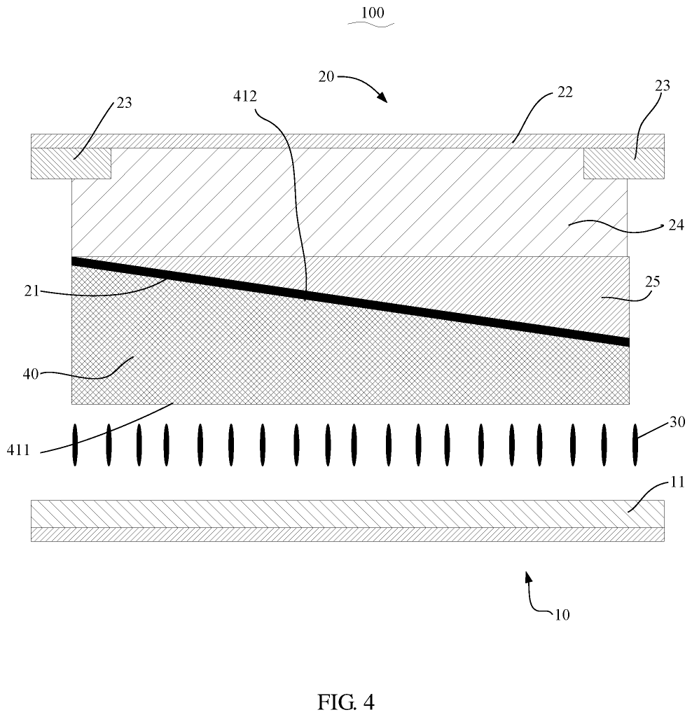

Referring to FIG. 4, in some embodiments of the present disclosure, the third surface is an inclined surface, and the second surface 412 matches with the inclined surface.

In some embodiments, the third surface is designed as the inclined surface, and the second surface 412 matches with the inclined surface, so that the effect of improving color shift can also be achieved assuming that the insulating layer 40 between the common electrode 21 and the liquid crystal layer 30 has the non-uniform thickness.

In some embodiments of the present disclosure, the third surface is an arc-shaped surface, and the second surface 412 matches with the arc-shaped surface.

In some embodiments, the third surface is designed as the arc-shaped surface, and the second surface 412 matches with the arc-shaped surface, so that the effect of improving color shift can also be realized assuming that the insulating layer 40 between the common electrode 21 and the liquid crystal layer 30 has the non-uniform thickness.

This present disclosure also provides a display device which includes a display panel 100, the specific structure of display panel 100 can be referred to the above-mentioned embodiments. As the display device adopts all the technical proposals of the above exemplary embodiments, the display device at least has all of the beneficial effects of the technical proposals of the above exemplary embodiments, no need to repeat again.

The display device of the embodiment may be any product or component with display function such as electronic paper, mobile phone, tablet computer, television, displayer, notebook computer, digital photo frame, navigator, etc.

The foregoing description merely depicts some embodiments of the present disclosure and therefore is not intended to limit the scope of the application. An equivalent structural or flow changes made by using the content of the specification and drawings of the present disclosure, or any direct or indirect applications of the disclosure on any other related fields shall all fall in the scope of the application.

1. A display panel, wherein, the display panel comprises:
a first substrate, the first substrate defines a pixel electrode;
a second substrate, facing the first substrate, a surface of the second substrate facing the first substrate defines a common electrode, and the common electrode faces the pixel electrode;
a liquid crystal layer, defined between the second substrate and the first substrate; and
an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different.

2. The display panel according to claim 1, wherein the insulating layer is defined on a surface of the common electrode near the liquid crystal layer.

3. The display panel according to claim 2, wherein the second substrate comprises a base substrate, and a black matrix, a color resistance layer, and a dielectric layer all sequentially defined on the base substrate, the common electrode is defined on a surface of the dielectric layer away from the color resistance layer, and a surface of the dielectric layer near the common electrode is defined as a third surface, a surface of the dielectric layer away from the common electrode is defined as a fourth surface, and vertical distances between the third surface and the fourth surface are different.

4. The display panel according to claim 3, wherein the third surface defines a first groove, the common electrode defines a second groove corresponding to the first groove, the second groove is received in the first groove, and the second surface defines a protrusion accommodated in the second groove.

5. The display panel according to claim 4, wherein the plane of an end of the protrusion located is parallel to the first surface, and the vertical distances between the planes of two sides of the second surface without the protrusion located and the first surface are defined as d1 and d4 respectively, d1=d4.

6. The display panel according to claim 3, wherein the third surface is an inclined surface, and the second surface matches with the inclined surface.

7. The display panel according to claim 3, wherein the third surface is an arc-shaped surface, and the second surface matches with the arc-shaped surface.

8. The display panel according to claim 1, wherein the first substrate defines data lines, scan lines, and a plurality of pixel units defined by the data lines and the scan lines, each of the pixel units includes a plurality of sub pixels, and each of the sub pixels includes the pixel electrode.

9. The display panel according to claim 8, wherein the pixel unit has an eight-domain structure.

10. The display panel according to claim 8, wherein each of the pixel units defines a four-domain display area.

11. The display panel according to claim 1, wherein the insulating layer is defined between the common electrode and the liquid crystal layer, and is located at a surface of the common electrode near the liquid crystal layer.

12. The display panel according to claim 1, wherein the insulating layer is defined between the pixel electrode and the liquid crystal layer, and is located at a surface of the pixel electrode near the liquid crystal layer.

13. The display panel according to claim 3, wherein the black matrix defines a light-transmitting region and an opaque region on the base substrate, and the color resist layer is defined in the light-transmitting region.

14. The display panel according to claim 3, wherein the common electrode is sandwiched between the dielectric layer and the insulating layer, and the common electrode has a uniform thickness along its extending direction.

15. A display panel, wherein, the display panel comprises:
a first substrate, the first substrate defines a pixel electrode;
a second substrate, facing the first substrate, a surface of the second substrate facing the first substrate defines a common electrode, and the common electrode faces the pixel electrode;
a liquid crystal layer, defined between the second substrate and the first substrate; and
an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different;
the second substrate comprises a base substrate, and a black matrix, a color resistance layer, and a dielectric layer all sequentially defined on the base substrate, the common electrode is defined on a surface of the dielectric layer away from the color resistance layer, and a surface of the dielectric layer near the common electrode is defined as a third surface, a surface of the dielectric layer away from the common electrode is defined as a fourth surface, and vertical distances between the third surface and the fourth surface are different, the third surface is an inclined surface, and the second surface matches with the inclined surface.

16. A display device, wherein the display device comprises a display panel, the display panel comprises:
a first substrate, the first substrate defines a pixel electrode;
a second substrate, facing the first substrate, a surface of the second substrate facing the first substrate defines a common electrode, and the common electrode faces the pixel electrode;
a liquid crystal layer, defined between the second substrate and the first substrate; and
an insulating layer, configured to isolate the liquid crystal layer from the common electrode, or isolate the liquid crystal layer from the pixel electrode, a surface of the insulating layer near the liquid crystal layer is defined as a first surface, the first surface is flush with the liquid crystal layer, a surface of the insulating layer away from the liquid crystal layer is defined as a second surface, and vertical distances between the second surface and the first surface are different.

17. The display device according to claim 16, wherein the insulating layer is defined at a surface of the common electrode near the liquid crystal layer; and
the second substrate comprises a base substrate, and a black matrix, a color resistance layer, and a dielectric layer all sequentially defined on the base substrate, the common electrode is defined on a surface of the dielectric layer away from the color resistance layer, and a surface of the dielectric layer near the common electrode is defined as a third surface, a surface of the dielectric layer away from the common electrode is defined as a fourth surface, and vertical distances between the third surface and the fourth surface are different

18. The display device according to claim 17, wherein the third surface defines a first groove, the common electrode defines a second groove corresponding to the first groove, the second groove is received in the first groove, and the second surface defines a protrusion accommodated in the second groove; and
the plane of an end of the protrusion located is parallel to the first surface, and the vertical distances between the planes of two sides of the second surface without the protrusion located and the first surface are defined as d1 and d4 respectively, d1=d4.

19. The display device according to claim 17, wherein the third surface is an inclined surface, and the second surface matches with the inclined surface; or the third surface is an arc-shaped surface, and the second surface matches with the arc-shaped surface.

20. The display device according to claim 16, wherein the first substrate defines data lines, scan lines, and a plurality of pixel units defined by the data lines and the scan lines, each of the pixel units includes a plurality of sub pixels, and each of the sub pixels includes the pixel electrode, the pixel unit has an eight-domain structure.
